(19) United States
(12) Patent Application Publication
(10) Pub. No.: US 2002/0138413 A1
(43) Pub. Date: Sep. 26, 2002

(54) Commercial mortgage closing process

(76) Inventors: David E. Creamer, Horsham, PA (US); Michael H. Greco, Davidson, NC (US); Edward R. Finkenstaedt, Wynnewood, PA (US); John Beam, Norcross, GA (US)

Correspondence Address: CHRISTOPHER DEVRIES, General Motors Corporation, Legal Staff Mail Code 482-C23-B21, P.O. Box 300, Detroit, MI, 48265-3000, US

(21) Appl. No.: 09/816,905

(22) Filed: Mar. 26, 2001

(51) Int. Cl. G06F 17/60

(52) U.S. Cl. 705/38

(57) ABSTRACT

A method for processing a loan including the steps of partnering with a third-party service provider, providing a loan production team, providing a loan closing team, gathering loan information on-line, the loan information provided to the third-party service provider, the loan production team, and the loan closing team, concurrently executing tasks by the third-party service providers, the loan production team, and the loan closing team to close the loan.

### TECHNICAL FIELD

The present method relates to a commercial mortgage process. More specifically, the present invention relates to a process for compressing the time needed to close on a commercial loan.

### BACKGROUND OF THE INVENTION

Processing and closing a commercial mortgage is a complex, time-consuming process. A commercial loan generally involves a borrower and a lender and may involve a broker. A borrower is an entity that desires to purchase a property or refinance a property it owns, and a broker is an entity that searches for a funding source or lender such as a bank or commercial mortgage lender. The borrower and lender will both have certain requirements such as a desired interest rate, loan amount, and transaction fees. A broker helps to negotiate the terms of the proposed transaction between the borrower and funding source to find the best match for the requirements.

The process of taking a loan from application to closing is generally in the neighborhood of 45 to 90 days. In today's commercial loan market, borrowers and funding sources desire a more streamlined approach to opening and closing a commercial loan. The benefits of a shortened or streamlined approach include taking advantage of drops in interest rates, avoiding losses when rates rise and meeting borrower debt covenants. Typically, the speed of processing a commercial loan is limited by a borrower's attorney, a borrower's accountants, a lender's attorney, a title insurance policy and third-party vendors hired by the lender. Such third-party vendors are hired to prepare borrower credit reports, property condition reports, a property appraisal, environmental reports, and engineering reports for a particular property. These third parties and the time needed to generate reports in a traditional loan process create a number of critical paths that can delay or disrupt the loan process.

A traditional commercial loan process includes negotiating a term sheet (preliminary loan terms subject to due diligence) and collecting a deposit, an underwriting review of the loan (which includes third-party reports and title insurance), executing a signed commitment, locking an interest rate, and the closing. The underwriting review step is the most time-consuming step of the traditional loan process because of the need to order, receive and review the third-party reports. The gathering and evaluation of information and the determination of risk are generally the critical paths in traditional commercial loan processing. The step of clearing title insurance is also time consuming because of the time needed to review the zoning regulations of the property.

### SUMMARY OF THE INVENTION

The present invention includes a streamlined method for processing and closing commercial loans. The method is based on “frontloading” data retrieval and task execution, simultaneously executing required tasks for processing a commercial loan, and balancing risk versus the time needed to process a commercial loan. The method of the present invention also eliminates the gathering and analysis of non-value added information processing to shorten the loan processing time.

The present invention further leverages the worldwide-web/internet as an information gathering and processing tool to quickly compile borrower information and compares that information to the lending programs of various large funding sources. The method of the present invention also engages third-party vendors early in the loan process. By integrating third-party vendors, all parties involved may execute tasks in parallel, removing critical paths to shorten the loan processing times.

Furthermore, the method of the present invention bypasses some of the traditional checks in the commercial mortgage industry by relying on insurance policies and eliminating steps that have been statistically demonstrated to only slightly increase risk. For example, zoning compliance does not pose a high risk but is a labor-intensive step in the title review and may be bypassed to shorten the loan processing time.

### BRIEF DESCRIPTION OF THE DRAWINGS

FIGS. 1A-1L are process diagrams of the preferred embodiment of the present invention.

### DESCRIPTION OF THE PREFERRED EMBODIMENT

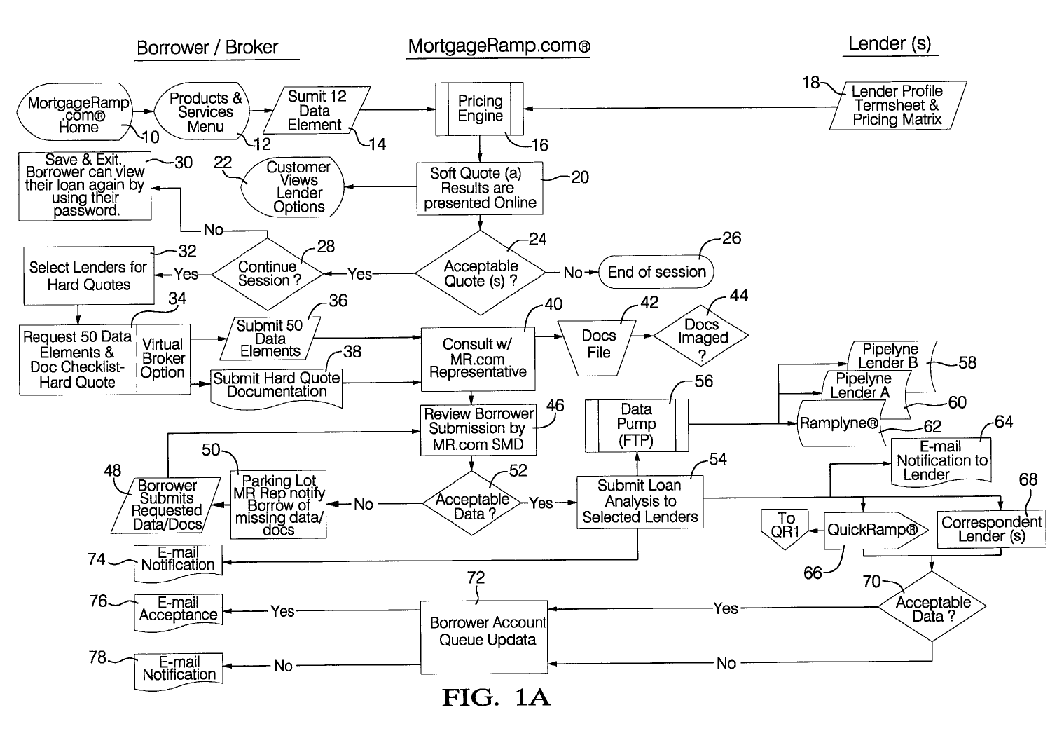

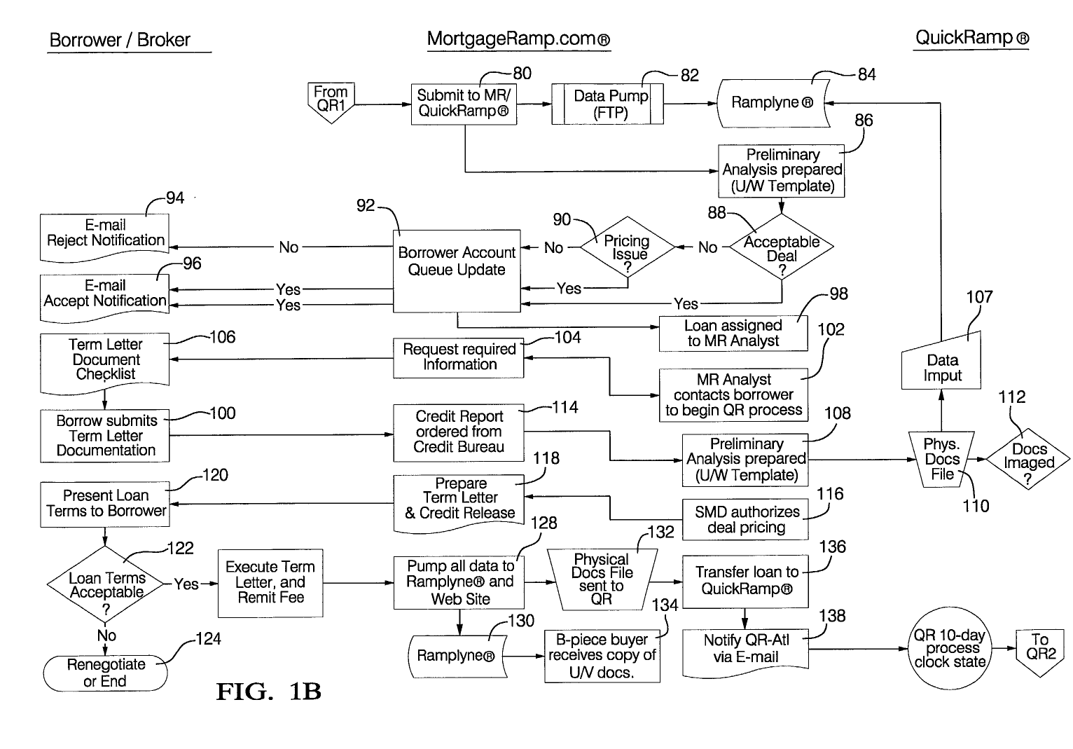

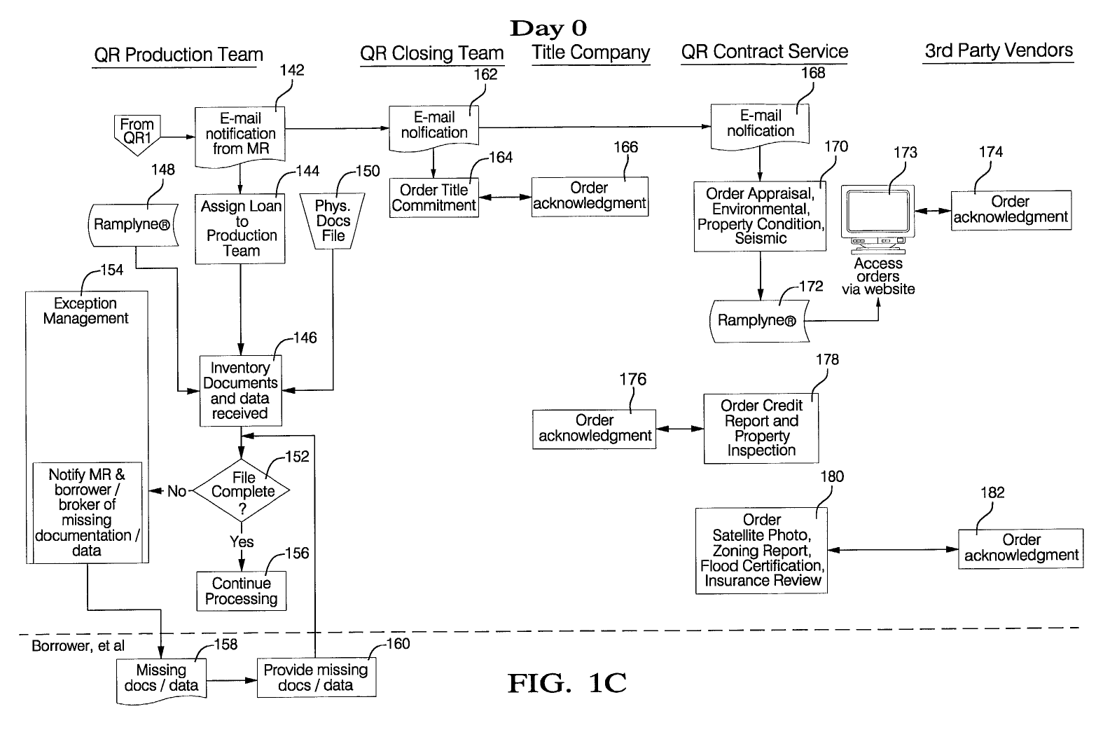

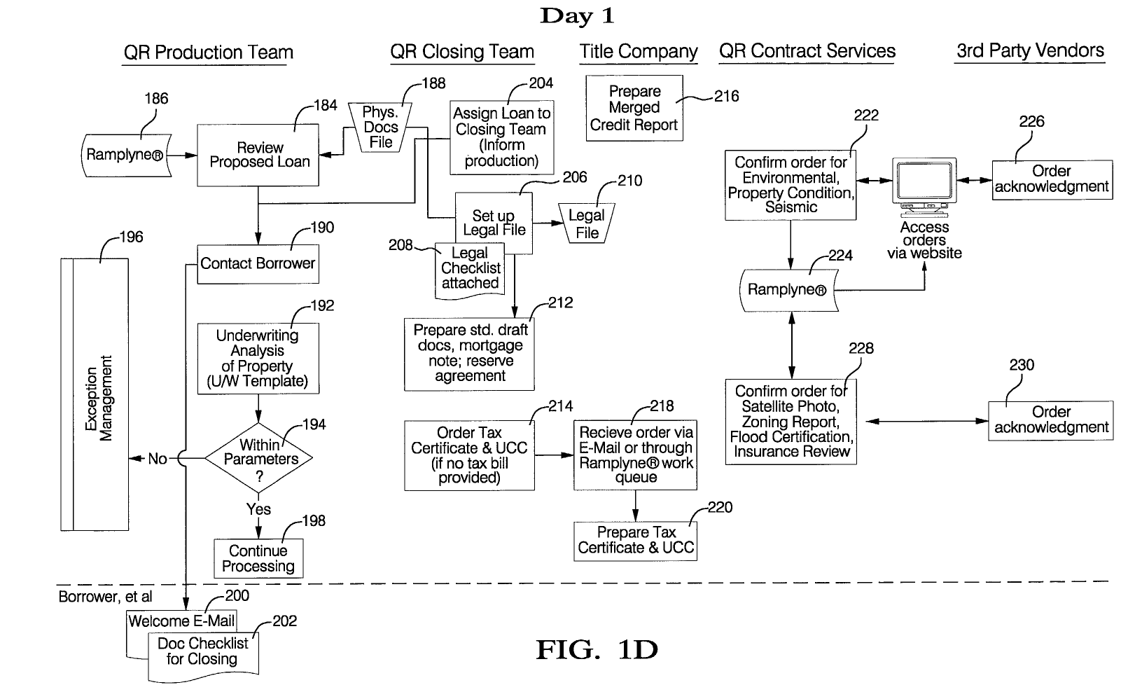

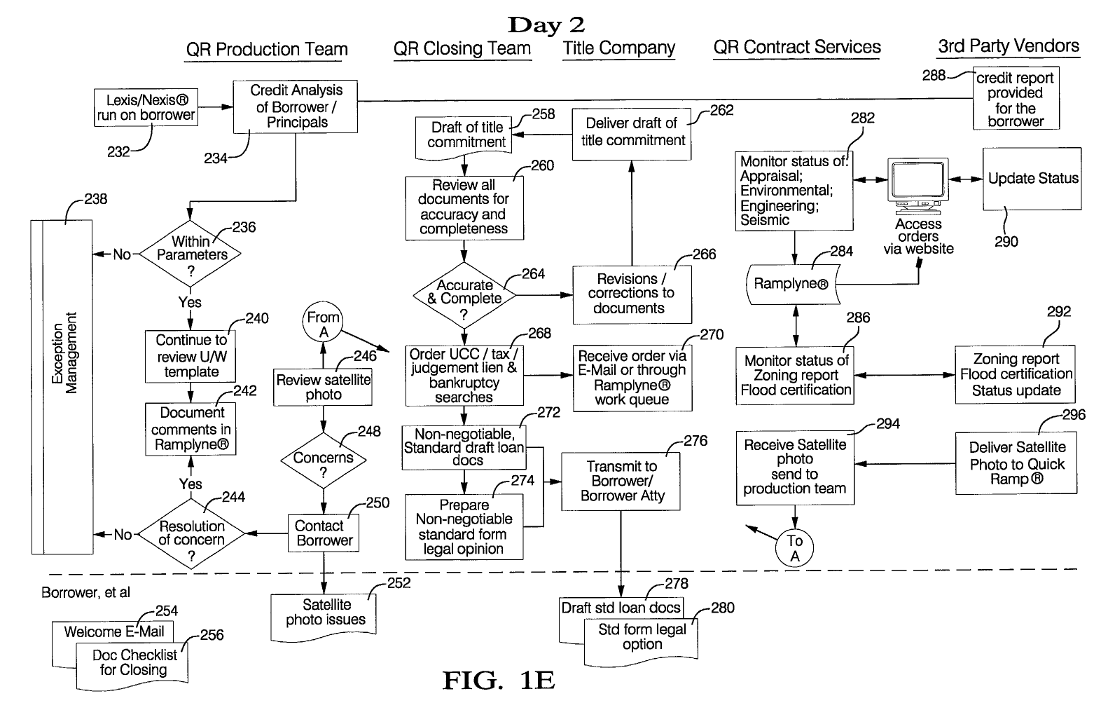

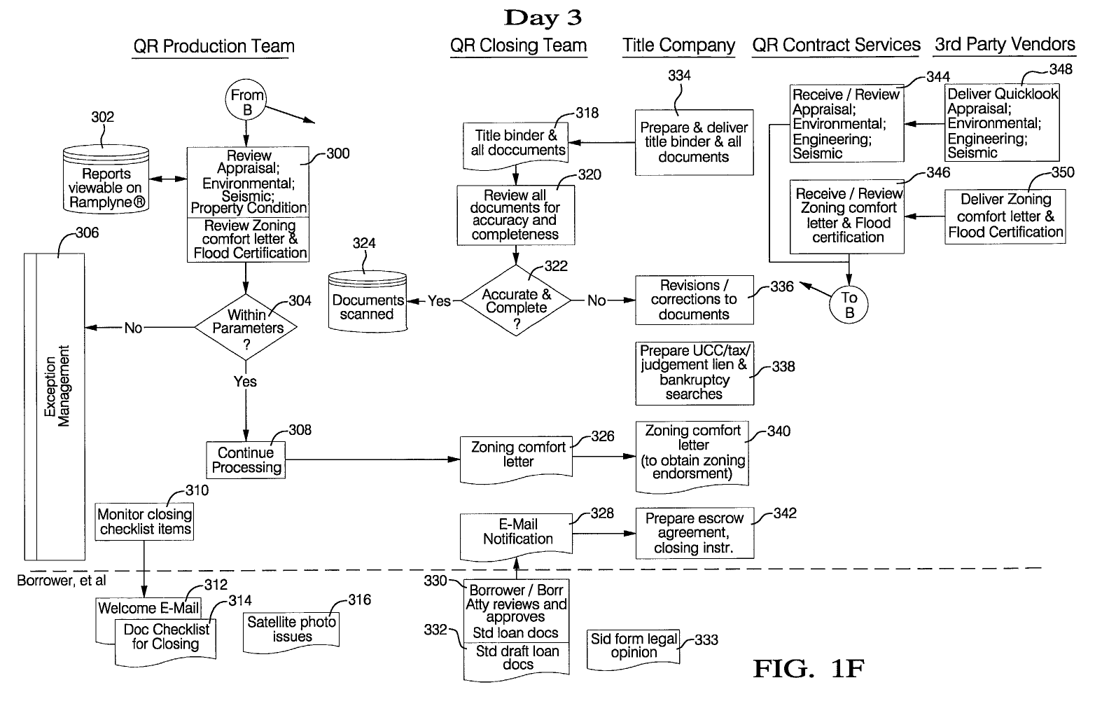

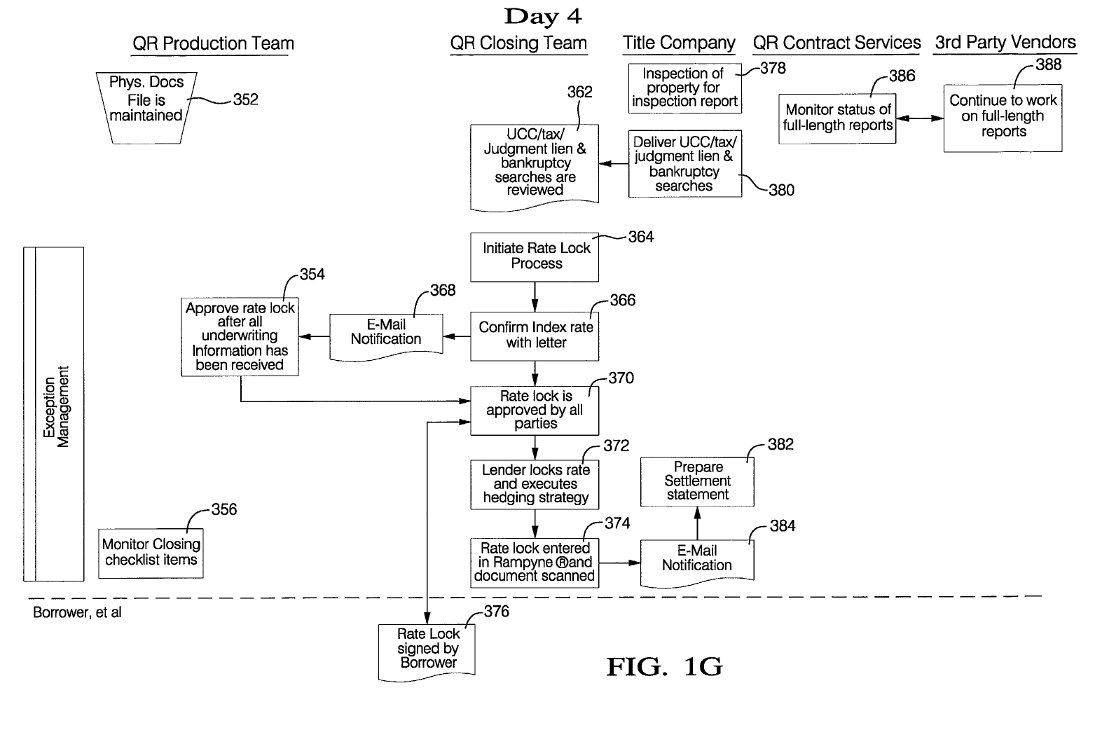

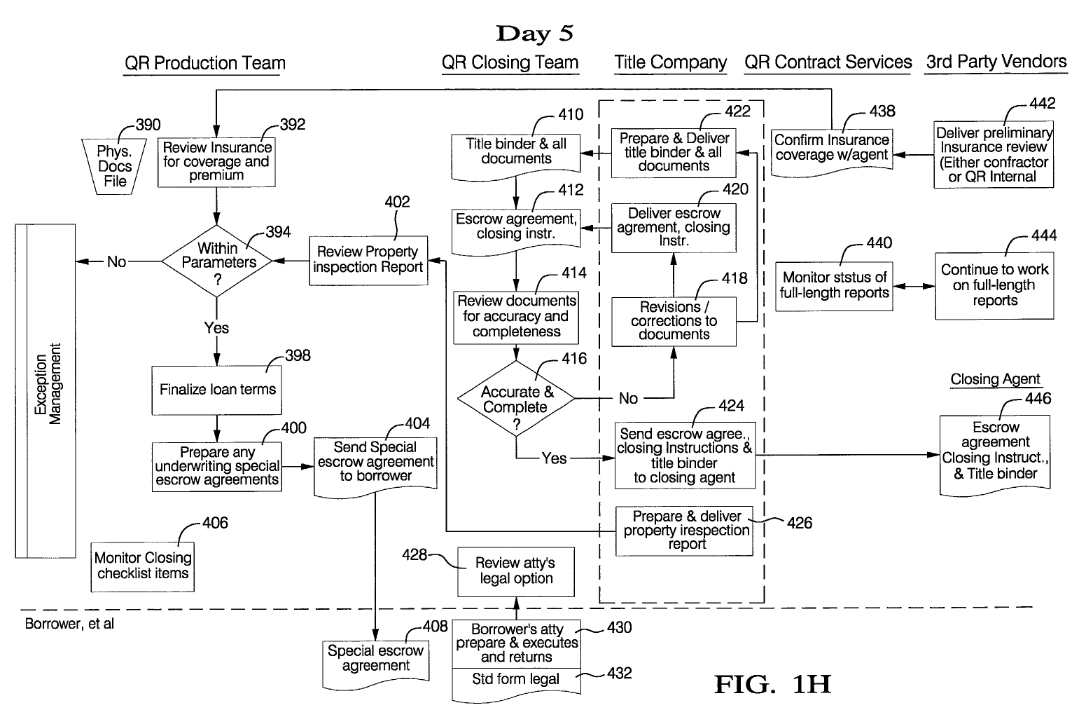

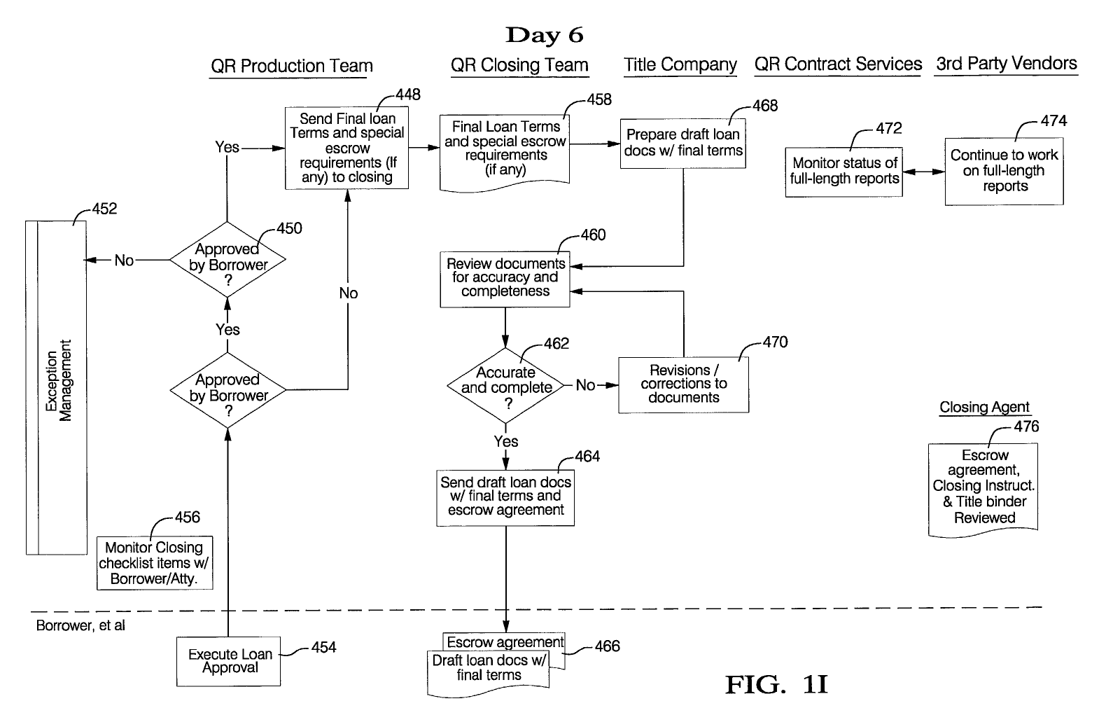

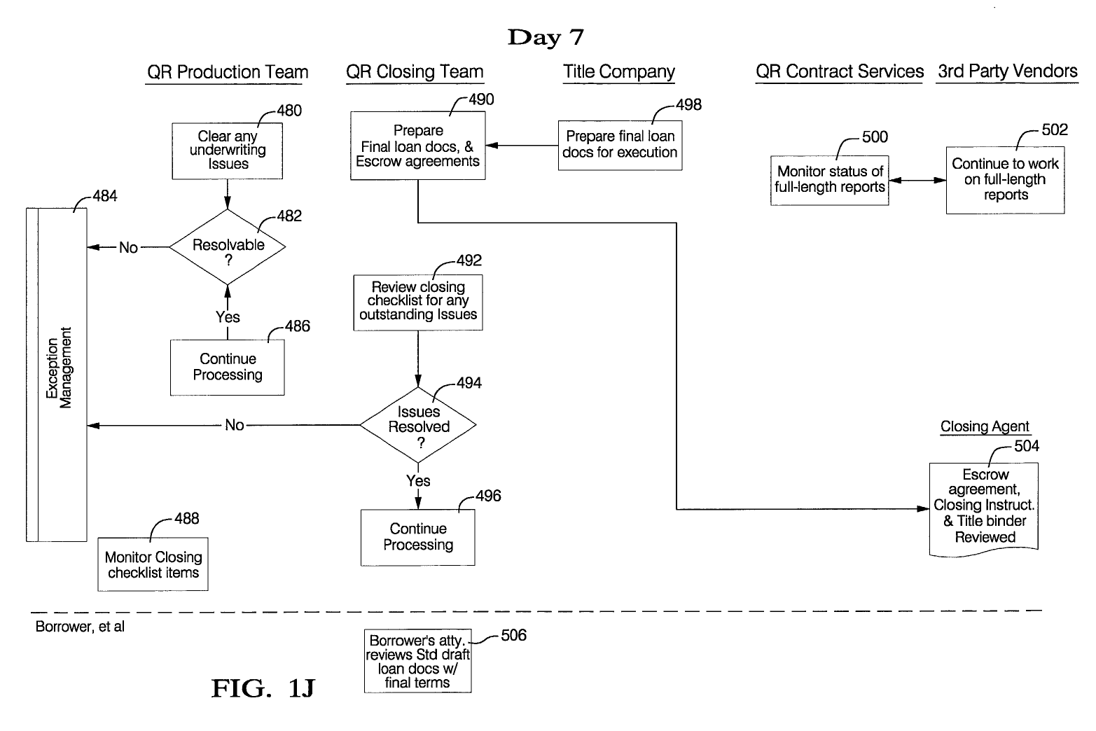

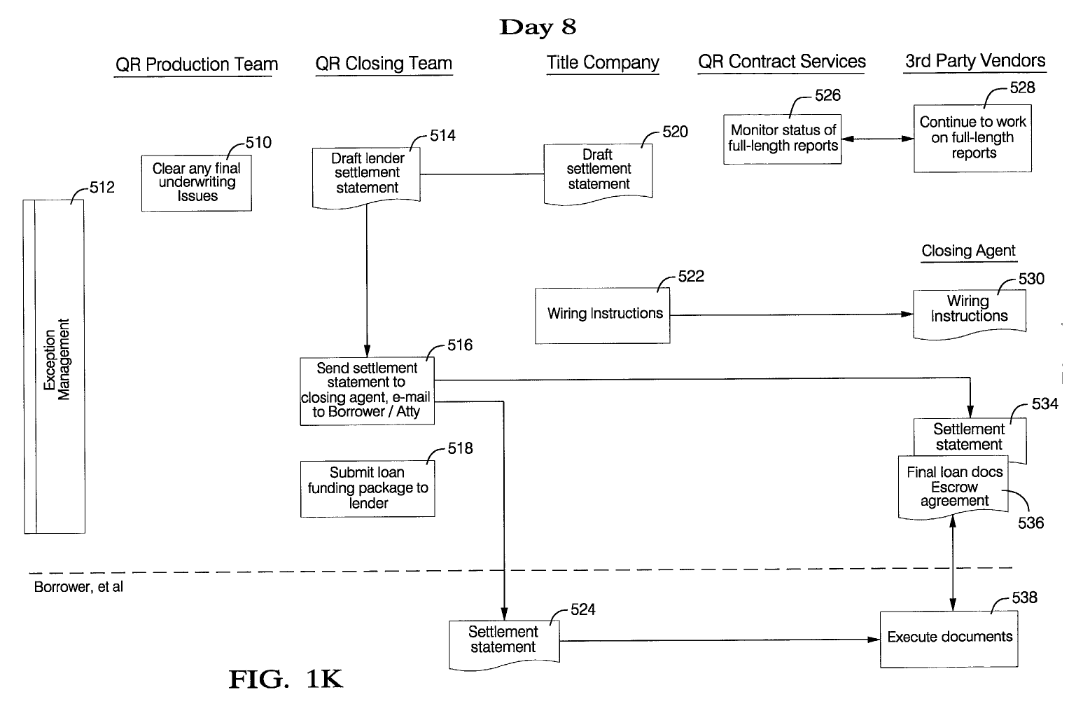

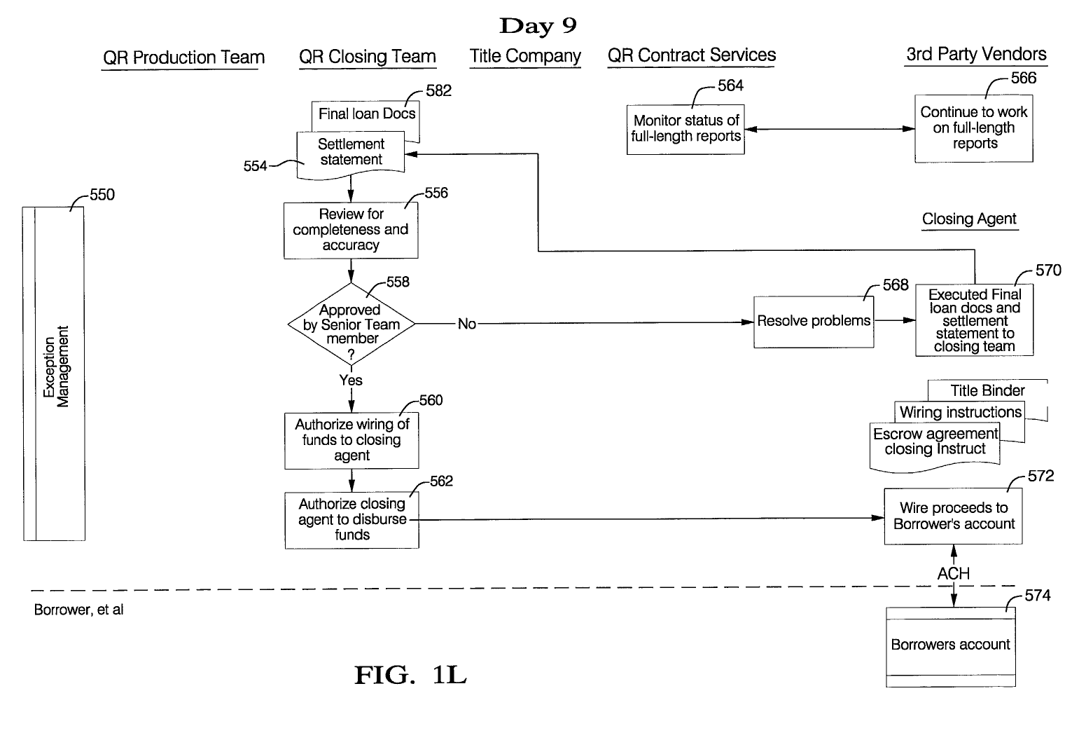

A broad overall process of the method of the preferred embodiment of the present invention is shown in FIGS. 1A-1L. FIG. 1A is the broad overview of the entire loan underwriting process of the present invention. Starting at block 10, a borrower or broker will access the MortageRamp.com® home page. At blocks 12 and 14, the borrower or broker will enter information into data fields to be processed. At block 16, a pricing engine will provide a list of loan programs (i.e., “soft quotes”) to the borrower or broker based on the information provided in the data fields. The soft quote information is based on a lender's loan program information provided at block 18. The loan program information includes, but is not limited to, minimum and maximum loan amounts, maximum loan-to-value ratios (the loan amount divided by appraised property value), property types, and geographic areas. A soft quote is an initial display of lender programs that correlate to or match the information provided. The soft quotes list the general lender parameters such as maximum loan-to-value, minimum debt service coverage ratio (the number of times operating income can pay the loan payment), minimum interest rate spread, fees, and closing costs. The soft quotes are presented online at block 20, and the borrower may review the soft quote options at block 22. The borrower is also presented a password at block 20 for future access to the loan information.

At block 24, the borrower determines if any of the soft quotes are acceptable. If the soft quotes are not acceptable, the session ends at block 26. If a borrower determines that there are any acceptable soft quotes, the borrower will continue to block 28 where the borrower will determine if he/she wishes to continue with the process. At block 30, the soft quotes may be saved for future access with the generated password. At block 32, the borrower will select hard quotes from their preferred lenders. The borrower can choose up to three lenders. Hard quotes are term sheets that the lender will give to the borrower. The term sheet documents the preliminary terms of the loan transaction prior to underwriting.

At block 34, the system will prompt the borrower to enter information necessary for the lender to generate hard quotes. At blocks 36 and 38, the borrower will submit the necessary data elements and the documentation needed to generate a hard quote. The data elements include, but are not limited to, a specific property address, current mortgage balance, net rentable square feet or number of units, borrower information, property rent roll and property operating statements. At block 40, the borrower will consult with a MortageRamp.com® loan representative to discuss additional documents that are needed prior to sending the loan to a lender such as the specifics of the borrowers financing needs and any questions the loan representative may have in connection with the submitted information. At block 42, a document file is created, and at block 44 any documents that are not in an electronic format are imaged and saved.

At block 46, the Senior Managing Director (SMD) will review the borrower loan information being forwarded to the selected lenders. The SMD responsibilities include reviewing the property information, the financial information and the market assumptions. At block 52, the SMD will determine if the deal is acceptable to be forwarded to the selected lenders. If the deal is not acceptable, then at block 50 a MortageRamp.com® executive will notify the borrower of any problems with the deal. At block 48, the borrower may attempt to correct any problems with the deal including the submission of any requested information and documents such that the deal may again be reviewed at block 46.

If an acceptable deal is determined at block 52, a loan analysis is sent to selected lenders at block 54 and an e-mail notification is sent at block 74 to the borrower. The borrower data at block 56 is transferred to lender databases at blocks 58, 60, and 62, via a data pump or file transfer protocol (FTP), and an e-mail notification is also sent to the lenders at block 64.

If the Quickramp® process was selected as a lender to give a hard quote, then the Quickramp® process will be engaged at block 66. The Quickramp® process is an expedited process for underwriting and closing a loan. The borrower will preferably incur higher costs for the expedited processing. The Quickramp® process has specific requirements for a loan based upon such information as property type and loan to value ratio. At block 68, the correspondent lender receives loan analysis.

At block 70, the deal is examined by the lender to determine its acceptability. The decision of acceptability is sent to the borrower via e-mail at blocks 76 and 78. A MortgageRamp® representative is also updated as to deal status in block 72.

FIG. 1B is an overview of the Quickramp® process selected by a borrower to expedite a loan. Block 80 through block 96 represent a repeat of activity shown in FIG. 1A. At block 80, the loan request is submitted to the Quickramp® process. The SMD at block 86 reviews the loan on the website. The SMD and borrower at block 88 determine if the deal is acceptable. If the deal is not acceptable, then at block 90 it is determined if pricing is the issue for the borrower. If pricing is not the issue for the closing of the deal, then at block 92 the borrower account information will be updated and an e-mail rejection notification will be sent at block 94 to the borrower. If pricing is the issue, then at block 92 pricing may be renegotiated to close the deal, the borrower account will be updated, and an e-mail acceptance notification will be sent at block 96 the borrower. After an acceptable deal between the borrower and lender has been created, the loan will be assigned to a MortgageRamp® analyst at block 98. At block 102, the MortgageRamp® analyst will begin to prepare the loan for the QuickRamp® process by contacting the borrower and requesting information, at block 104, that was not provided during the MortgageRamp® screening but is required to underwrite the loan. At block 106, the document checklist for the term letter will be sent to the borrower to inform the borrower of the documents necessary for the QuickRamp® process to issue a term letter. The borrower at block 100 submits term letter documentation, and at block 114 a credit report is ordered from a title company.

At block 108, a preliminary analysis is prepared using an underwriter template to analyze the borrower's financial statements and the underwriters financial assumptions. The analysis is transferred to a physical document file at block 110 and imaged at block 112 for storage. The document file is also transferred to data input at block 107 so the preliminary analysis can be included in the Ramplyne® database in electronic format at block 84. Ramplyne® is a database containing loan data in electronic format.

At block 116, the Senior Managing Director (SMD) authorizes the deal pricing, and a term letter and credit release are prepared at block 118. At block 120, the loan terms are presented to the borrower. At block 122, the borrower determines if the loan terms are acceptable. If the loan terms are not acceptable to the borrower, then at block 124 the terms will be renegotiated or the process will end. If the loan terms are acceptable, then at block 126, a term letter is executed and a remittance fee is paid by the borrower. At block 128, all of the data is pumped to Ramplyne® and the web site for MortageRamp.com®. At block 132, the physical documents are sent to the Quickramp® operations, and the loan processing is transferred to Quickramp® for expedited processing and an e-mail notification is sent at block 138. At block 140, the Quickramp® clock starts.

At block 130, Ramplyne® has been updated with the most recent loan information. At block 134, the B-piece buyer receives copies of the underwriting documents. The B-piece buyer is the entity that will be assuming the first loss position in each loan in the event of a loan default. The B-piece buyer will perform a preliminary review of the loan data.

Referring to FIGS. 1C-1L, the preferred 10-day time window for executing the expedited Quickramp® loan process is detailed. While the process is described in terms of 10 days, any compressed time period for loan processing is within the scope of the present invention. At the top of FIGS. 1C-1L, the preferred participants in the processing of a Quickramp® loan are listed and their corresponding tasks are generally listed below them in FIGS. 1C-1L. The participants include a production team, a closing team, a title company, a contract services team and third-party vendors. The production team is responsible for taking inventory of the documents provided by the all parties involved. The closing team is responsible for closing the loan. The contract services team is responsible for ordering third-party reports, receiving and reviewing the reports and updating Ramplyne® as to the status of those reports. The third-party vendors comprise various companies in the business of preparing reports for commercial real estate lending. The third-party vendors may provide reports that include, but are not limited to, property condition reports, a property appraisal and/or an environmental report. The title company and third-party vendors are fully integrated into the Quickramp® loan process through sharing common space, contractual agreement and use of the worldwide web. By fully integrating and communicating at the beginning of the Quickramp® loan process to the title company and third-party vendors, the commercial loan transaction timeframe can be compressed, and any unnecessary lock-step procedures can be eliminated.

FIG. 1C describes the first day or day 0 of the Quickramp® expedited loan processing method. The production team receives e-mail notification of a loan to be processed by the Quickramp® process at block 142. At block 144, the loan is assigned to the production team. The production team inventories documents and data at block 146 such as physical document files sent at block 150 and data listed in Ramplyne® at block 148. The production team at block 152 determines if the file is incomplete. An incomplete file, for example, could comprise a file lacking a credit report, a borrower's financial statements or a copy of the term sheet. If the file is not complete, then the file will be placed in exception management at block 154. Exception management will be discussed frequently in the following description and comprises the tasks needed to get a loan application back into the Quickramp® process after an irregularity or problem has been detected.

The borrower and broker at block 154 will be notified of the problem and any missing documentation, and the clock for Quickramp® will be stopped. Missing documents and data will be acquired at blocks 158 and 160 and the process will return to block 152 to again determine if the file is complete. If the file is complete, processing of the loan by the production team will continue at block 156.

The closing team also receives e-mail notification of the loan to be processed by the Quickramp® process at block 162. The closing team will order a title commitment at block 164, and an acknowledgement at block 166 for the order will be sent from the title company. A title commitment is defined generally as a commitment by the title insurance company to provide title insurance.

The contract services team also receives e-mail notification of the loan to be processed by the Quickramp® process at block 168. At block 170, the contract services team orders information on the property including, but not limited to, an appraisal, an environmental report, a property condition report and a seismic report. The request for the reports is input to Ramplyne® at block 172 and third-party vendors are notified of the order via the MortgageRamp® web site on the worldwide web at block 173. The third-party vendors provide order acknowledgements via the MortgageRamp® web site on the worldwide web at block 174.

At block 178, the contract services team orders credit reports and property inspection information from the title company, and the title company will communicate an acknowledgment of the order at block 176. At block 180, the contract services team orders a satellite photo(s), zoning reports, flood certification, and insurance review from third-party vendors. The third-party vendors will acknowledge the order at block 182.

As can be seen in FIG. 1C and the remaining figures, the participants in the Quickramp® loan processing method of the present invention work in parallel to expedite the loan. The concurrent task execution allows the method of the present invention to compress the time needed to process a loan, as compared to traditional loan processes.

FIG. 1D describes day 1 of the Quickramp® expedited loan processing method. At block 184, the production team reviews the proposed loan after receiving any updated borrower information or third-party reports stored in Ramplyne® or the physical document files at blocks 186 and 188. At blocks 190, 200 and 202, the borrower is contacted and given a checklist for the closing of the loan. The checklist informs the borrower of the documents that need to be provided before the transaction can be closed. At block 192, the production team reviews the underwriter template that was prepared in block 108. At block 194, the production team determines if the loan is within the parameters of the loan process. If the loan is not within parameters, then the loan enters exception management at block 196 (as in block 154). If the loan is within parameters, processing continues at block 198.

At block 204, the loan is assigned to the closing team, and the production team is made aware of which closing team was assigned. At blocks 206 and 208, a legal file is set up with a legal checklist, and at block 210 the legal file is filed electronically for storage. At block 212, the closing team prepares draft documents including a mortgage note and a reserve agreement. At block 214, the closing team orders the tax certificate if no tax bill has been provided and the uniform commercial code (U.C.C.) report from the title company. The U.C.C. report is generally directed toward Article 9 secured transaction issues, as is known in the art.

At block 216, the title company prepares a merged credit report. At blocks 218 and 220, the title company receives the order for a tax certificate and the U.C.C. report from the closing team and prepares the tax certificate and the U.C.C. report.

At block 222, the contract services team confirms an order for an appraisal, engineering reports, environmental information, and other information from third-party vendors. The Ramplyne® database is updated at block 224 with information from the third-party vendors. The contract services team at block 228 confirms their orders for a satellite photo, zoning reports, flood certification, insurance reviews from third-party vendors and other information. The third-party vendors at blocks 226 and 230 acknowledge the ordering of information by the contract services team.

FIG. 1E describes day 2 of the Quickramp® expedited loan processing method. At block 232, the production team does a Lexis/Nexis® search or a search on any other database containing information that is of public record such as court records or newspaper archives pertaining to the subject property and parties. At block 234, the production team prepares an analysis of the borrower and principal(s) based upon information from third-party vendors at block 288. The analysis at block 236 determines whether the loan is within the expedited loan parameters. If the loan is not within the expedited loan parameters, then the loan will enter exception management at block 238. If the loan is within parameters, then the production team continues to review the loan application using the underwriting template at block 240 and information in Ramplyne® at block 242. At block 244, the production team determines if all concerns have been resolved. If all the concerns have not been resolved, the loan will enter exception management at block 238.

At block 246, the production team will review satellite photos of the property at issue sent by the contract services team. At block 248, the production team will determine if there are concerns and contact the borrower at block 250 and send the borrower a copy of the satellite photo at block 252. At block 244, the production team will again determine if all concerns have been resolved. Blocks 254 and 256 illustrate that the borrower still has possession of the welcome e-mail and the document checklist for closing.

The closing team at block 258 will review the draft title commitment. At block 260, the closing team will review all the documents received to date for accuracy and completeness. At block 264, the closing team determines if all documents received to date are accurate and complete. After confirming that the information is accurate and complete, the closing team orders the U. C. C. report, the tax judgment lien, and bankruptcy searches from the title company at block 268. At block 272, the closing team drafts a non-negotiable standard draft loan document. At block 274, the closing team prepares a standard form legal opinion for the borrower's attorney with a copy being sent to the borrower at blocks 276 and 278. The borrower's attorney issues the standard form legal opinion on the borrower letterhead and signed by the borrower. The opinion states that the borrower is authorized to sign the closing documents, that the borrower is properly organized under the applicable state laws, and that the legal documents are enforceable.

The title company at block 262 delivers the draft title commitment to the closing team. The title company, as directed by the closing team at block 266, may generate revisions and corrections to documents. The title company, via e-mail, receives an order from the closing team for U.C.C., tax, judgment, lien, and bankruptcy searches at block 270.

The contract services team at block 282 continues to monitor the status of third-party vendor reports including, but not limited to, appraisal, environment, engineering, and seismic (if required). At block 284, the contract services team updates the Ramplyne® database. At block 286, the contract services team monitors the status of zoning reports and flood certification and to update the Ramplyne® database. At block 294, the contract services team receives the satellite photo from third-party vendors and sends the satellite photos to the production team.

The third-party vendors at block 290 update the status of third-party reports by e-mailing contract services or by accessing the MortgageRamp® web site. At block 292, the third-party vendors transfer zoning reports, flood certification and/or a status update. At block 296, the third-party vendors will deliver the satellite photo to contract services.

FIG. 1F describes day 3 of the Quickramp® expedited loan processing method. The production team at block 300 will receive and review the appraisal, zoning, comfort letter, flood certification and environmental, engineering, and seismic third-party reports from the contract services team. At block 304, the production team will determine if the reports and other information are within the QuickRamp® loan parameters. If the information is not within parameters, the loan will enter into exception management at block 306. If the loan is within parameters, processing will continue at block 308. At block 310, the production team will continue to monitor checklist items and continue to have contact with the borrower and/or borrower's attorney to ensure that the documents on the closing checklist are being obtained. Blocks 312, 314 and 316 indicate that the borrower is in possession of the welcome e-mail, document checklist, and satellite photo of the property.

The closing team at block 318 receives the title binder and other documents from the title company. At blocks 320 and 322, the closing team continues to review all the documents for accuracy and completeness. If the documents are accurate and complete, they are scanned and electronically stored at block 324. If the documents are not accurate and complete, they are returned to the title company for corrections. At block 326, the closing team receives the zoning comfort letter and transfers it to the title company. At block 328, the closing team receives e-mail notification from the borrower and/or the borrower's attorney that they have approved the standard loan documents indicated in block 330. Blocks 332 and 333 indicate that the borrower is in possession of the draft loan documents and the standard form legal opinion.

The title company at block 334 prepares and delivers to the closing team the title binder and all other necessary documents. At block 336, the title company corrects any problems with the documents as determined by the closing team. At block 338, the title company continues to prepare the U.C.C. and tax documents and executes a search for judgments, liens, and bankruptcies. At block 340, the title company receives the zoning comfort letter from the closing team, and at block 342 the title company prepares the escrow agreement and the closing instructions based upon the standard form legal documents approved by the borrower.

The contract services team at block 344 receives and reviews appraisal, environmental, engineering, and seismic reports from third-party services, and at block 346 the contract services teams receives and reviews the zoning comfort letter and flood certification. This information is all transferred to the production team.

The third-party vendors at blocks 348 and 350 deliver the appraisal, environmental, engineering and seismic reports, the zoning comfort letter and flood certification to the contract services team.

FIG. 1G describes day 4 of the Quickramp® expedited loan processing method. The production team at block 352 continues to maintain the physical documents in a file. At block 354, the production team approves a rate lock after all the underwriting information has been sent from the closing team and then the production team notifies the closing team of the approval at block 370. At block 356, the production team continues to monitor the closing checklist items.

At block 362, the closing team reviews the U.C.C. and tax forms and the results from the judgment lien and bankruptcy searches received from the title company. At block 364, the closing team prepares the lock rate agreements. The interest rate is confirmed with the lender at block 366 and e-mail notification is sent to all parties to the transaction at block 368. After the production team approves the rate lock at block 354 and the borrower approves the rate lock at block 376, the rate lock has then been approved by all the parties at block 370. At block 372, the lender locks the interest rate and executes a hedging strategy, Ramplyne® is updated at block 374 and a notification is sent to the title company at block 384.

The title company at block 378, based on a preliminary inspection report, prepares the final inspection report. At block 380, the title company delivers to the closing team the U.C.C. and tax forms as well as the results of the judgment lien and bankruptcy searches. At block 382, the title company prepares a settlement agreement after receiving a notification at block 384 from the closing team that the interest rate has been locked.

The contract services team at block 386 monitors the status of the full length reports generated by third-party vendors at block 388.

FIG. 1H describes day 5 of the Quickramp® expedited loan processing method. The production team at block 390 continues to maintain the physical documents generated by the process. At block 392, the production team reviews the preliminary property insurance coverage report and the premium expense report prepared by the third-party vendors. If the coverage and premiums are not within the parameters or the property inspection received at block 402 from the title company is not within parameters, then the loan enters exception management at block 396 where the production team attempts to resolve these problems. If the coverage and premium are within parameters, then the production team finalizes the loan terms at block 398. At block 400, the production team prepares the final approval including any underwriting special escrow agreements, and at blocks 404 and 408 the special escrow agreements are sent to the borrower for review and approval. At block 406, the production team continues to monitor the closing checklist items.

The closing team receives the title binder and all documents at block 410 from the title company. At block 412, the escrow agreement and closing instructions are received by the closing team from the title company. The documents are reviewed at blocks 414 and 416 to determine if they are accurate and complete. If all documents are accurate and complete, the closing team instructs the title company, at block 424, to send the escrow agreement, closing instructions, and title binder to the closing agent at block 446. If any document is inaccurate or not complete, it is sent back to the title company for correction. At block 428, the closing team will review the legal opinion submitted by the borrowers attorney at block 430.

The title company at block 422 prepares and delivers the title binder and all documents to the closing team. At block 420, the title company delivers to the closing team the escrow agreement and closing instruments that were initially correct or corrected at block 418 by the title company. At block 426, the closing company prepares and delivers a property inspection report to the production team. The contract services team at block 438 confirms insurance coverage from a third-party vendor and sends the policy to the production team for review. At block 440, the contract services team continues to monitor the status of reports generated by the third-party vendors.

The third-party vendors at block 442 deliver preliminary insurance review to the contract services team, and at block 444 the third-party vendors continue to work on the full-length reports. A closing agent at block 446 receives from the title company the escrow agreement, loan closing instructions, and the title binder.

FIG. 1I describes day 6 of the Quickramp® expedited loan processing method. At block 454, the borrower executes the loan approval and sends it to the production team for review at block 452. If there are no special escrow requirements, then the production team sends the final loan terms to the closing teams at block 448. If there are special escrow terms at block 452, then the production team determines if they were approved by the borrower at block 450. If the escrow agreement is not approved by the borrower, the loan enters exception management at block 452. If the special escrow agreement is approved by the borrower, then the production team sends the final loan terms and escrow requirements to the closing team in block 448.

The closing team receives final loan terms and any special escrow agreement at block 458 from the production team and transfers them to the title company. At blocks 460 and 462, the closing team reviews the draft loan documents and revisions and corrections generated by the title company. If the draft loan documents are accurate and complete, the draft loan documents and escrow agreement are sent to the borrower at block 464. The final terms for the escrow agreement and draft loan documents are reviewed by borrower and/or borrower's attorney at block 466.

The title company at block 468 prepares the draft loan document with final loan terms generated by the closing team and then sends the loan documents back to the closing team. At block 470, the title company revises and corrects any documents that are not accurate or complete, as indicated by the closing team.

The contract services team at block 472 continues to monitor the status of full-length reports generated by third-party vendors at block 474. The closing agent at block 476 continues to review the escrow agreement, the closing instructions, and the title binder previously provided in FIG. 1H, block 446.

FIG. 1J describes day 7 of the Quickramp® expedited loan processing method. The production team clears any underwriting issues at block 480. At block 482, the production team determines if there are underwriting issues that cannot be resolved. If there are underwriting issues that cannot be resolved, the loan enters exception management at block 484. If there are no underwriting issues or the issues are easily resolvable, then the processing of the loan continues at block 486. At block 488, the production team will continue to monitor the closing checklist.

The closing team at block 490 reviews the final loan documents and prepares the loan closing package and the escrow agreement, and then forwards these documents to the closing agent at block 504. At blocks 492 and 494, the closing team reviews the closing checklist for any outstanding issues. If there are outstanding issues, the loan enters exception management at block 484. If there are no outstanding issues, then the processing of the loan continues at block 496.

The title company at block 498 prepares final loan documents for execution and sends them to the closing team.

The contract services team at block 500 continues to monitor the status of full-length reports generated by third-party vendors at block 502. The closing agent at block 504 receives from the closing team the closing package, the final loan documents, and the escrow agreement.

The borrower reviews the loan documents with final terms at block 506.

FIG. 1K describes day 8 of the Quickramp® expedited loan processing method. The production team at block 510 clears away any final underwriting issues and signs off to close.

The closing team receives the draft lender settlement statement from the title company at block 514. At block 516, the closing team sends the settlement statement to the closing agent. At block 518, the closing team submits the loan-funding package to the lender.

The title company drafts the settlement agreement and sends it to the closing team at block 520. At block 522, the closing team sends the wiring instructions to the closing agent.

The contract services team at block 526 continues to monitor the status of full-length reports generated by third-party vendors at block 528. The closing agent at block 530 receives from the closing team the wiring instructions. At blocks 534 and 536, the closing agent receives the settlement statement and the final loan documents from the closing team.

The borrower at block 524 reviews the settlement statement and executes all the documents in conjunction with the closing agent at block 538.

FIG. 1L describes day 9 of the Quickramp® expedited loan processing method. The production team is idle unless exception management is in process at block 550.

The closing team receives the final loan documents and settlement statement at blocks 552 and 554 from the closing agents. At block 556, the closing team reviews the final loan documents and settlement statement for accuracy and completeness. At block 558, a senior team member of the closing team determines if the final loan documents are accurate and complete. If there are problems with the final loan documents, the closing team returns the documents to the closing agent at block 568. If the documents are accurate and complete, the closing team authorizes the wiring of funds to the closing agent at block 560. At block 562, the closing team authorizes the closing agent to disburse funds.

The contract services team at block 564 continues to monitor the status of full-length reports generated by third-party vendors at block 566.

The closing agent at block 570 receives from the closing team problems with the accuracy or completeness in the final loan documents or the settlement agreement and revises the final loan documents and settlement agreement to send to the closing team. At block 572, the closing agent receives authorization to disburse funds, and at block 574, the closing agent wires the funds to the borrower's account.

While this invention has been described in terms of some specific embodiments, it will be appreciated that other forms can readily be adapted by one skilled in the art. Accordingly, the scope of this invention is to be considered limited only by the following claims.

1. A method for processing a loan comprising the steps of:
partnering with a third-party service provider;
providing a loan production team;
providing a loan closing team;
gathering loan information on-line, said loan information provided to said third-party service provider, said loan production team, and said loan closing team; and
concurrently executing tasks by said third-party service providers, said loan production team, and said loan closing team to close the loan.

2. The method of claim 1 wherein the step of partnering third-party service providers comprises partnering with a title company.

3. The method of claim 1 wherein the step of partnering third-party service providers comprises partnering with an engineering company.

4. The method of claim 1 wherein the step of partnering with a third-party service provider comprises establishing a communication link with said third-party service provider to enable said third-party service provider to receive said loan information within 24 hours.

5. The method of claim 1 further comprising the step of said loan production team reviewing appraisal, environmental, and engineering information.

6. The method of claim 1 further comprising the step of said closing team drafting a loan document.

7. The method of claim 1 wherein the step of gathering loan information on-line comprises providing a web site for borrowers and brokers to access a loan application.

8. A method of underwriting a commercial loan comprising:
accessing borrower loan information;
accessing lender loan information;
providing a signed loan application in under 72 hours using said borrower and lender loan information;
generating an appraisal in under 96 hours;
evaluating title and credit of said borrower in under 96 hours; and
closing said loan in under 240 hours.

9. The method of claim 8 wherein said step of accessing borrower information is done via the internet.

10. The method of claim 8 wherein said step of providing a signed loan application is executed by a production team.

11. The method of claim 10 wherein said step of evaluating said title and credit of said borrower is executed by a production team.

12. The method of claim 11 further comprising said closing and production teams executing tasks in parallel.

13. The method of claim 12 further comprising the step of partnering third-party service providers to execute tasks in parallel with said production and closing teams.

14. The method of claim 13 wherein said third-party service providers comprise at least a title company.

15. A method of online loan processing comprising:
providing a website to compile borrower loan information and interact with said borrower;
providing a selection of applicable loan programs based on said borrower information;
selecting an expedited process based on said borrower input;
reviewing a loan inquiry;
providing a loan production team;
providing a loan closing team;
partnering with third-party service providers;
said loan production team, closing team, and said third-party service providers executing tasks in parallel; and
closing the loan in under 1080 hours.

16. The method of claim 15 wherein the step of closing the loan in under 1080 hours comprises closing the loan in under 240 hours.

17. The method of claim 1 wherein the step of partnering third-party service providers comprises partnering with an engineering company.

18. The method of claim 15 wherein the step of partnering with a third-party service provider comprises establishing a communication link with said third-party service provider to enable said third-party service provider to receive said loan information within 24 hours.

19. The method of claim 15 further comprising the step of said loan production team reviewing appraisal, environmental, and engineering information.

20. The method of claim 15 further comprising the step of said loan closing team drafting a loan document.

21. The method of claim 15 wherein the step of partnering with a third-party service provider comprises integrating a third-party service party into the loan process.

22. A method of processing a commercial loan comprising the steps of:
compiling borrower information;
compiling lender information;
providing a selection of applicable loan programs;
entering an expedited loan process;
generating a signed loan application by a production team;
generating a loan document by a closing team;
clearing title through a title company;
generating an appraisal with third-party services;
operating said production team, closing team, title company, and third-party services in parallel to process the commercial loan; and
closing the commercial loan.

23. The method of claim 22 wherein the step of closing the commercial loan comprises closing the commercial loan in under 240 hours.

24. An method of processing a commercial loan comprising the steps of:
compiling borrower information;
compiling lender information;
providing a selection of applicable loan programs;
entering an expedited loan process;
generating a signed loan application by a production team;
generating a loan document by a closing team;
clearing title through a title company;
generating an appraisal with third-party services;
operating said production team, closing team, title company, and third-party services in parallel to process the commercial loan; and
closing the commercial loan.
